(19) United States
(12) Patent Application Publication
(10) Pub. No.: US 2011/0070391 A1
(43) Pub. Date: Mar. 24, 2011

(54) RELEASABLY ADHESIVE TAPES

(75) Inventor: Stephen Cotton, Nottinghamshire (GB)

(73) Assignee: Brightwake Limited, Nottingham, Nottinghamshire (GB)

(21) Appl. No.: 12/993,402

(22) PCT Filed: May 12, 2009
(86) PCT No.: PCT/GB2009/050500

§ 371 Date: Nov. 18, 2010

(30) Foreign Application Priority Data
May 20, 2008 (GB) 0809131.6

(51) Int. Cl. B32B 3/10; B32B 37/02

(52) U.S. Cl. 428/43; 156/253

(57) ABSTRACT

An adhesive tape, particularly suitable for medical applications, comprises a structural layer carrying on at least one part of one side thereof a hydrophobic gel and on at least part of the other side thereof a backing layer. The structural layer comprises a synthetic material in the form of a film or non-woven web. The tape has separation lines comprising perforations extending laterally across the tape at regular intervals along the length of the tape. The hydrophobic gel that is carried on one side of the structural layer is preferably a soft silicone.

This invention relates to releasably adhesive tapes, in particular tapes carrying soft silicone adhesive. More specifically, the invention relates to such tapes that are dispensed from a roll. The tapes are particularly suitable for use in medical applications.

Medical tapes are required for many different applications, such as holding wound dressings in place, securing tubes and other medical devices to the skin, and strapping.

Medical tapes are commonly dispensed from a roll. Preferably, the structural layer(s) of a medical tape are strong and conformable, with sufficient stretch to accommodate swelling and movement. As a consequence, a length of tape cannot easily be torn by hand from the roll. Thus, it is usual that medical tapes must be cut using scissors or the like. This is more time-consuming and cumbersome than tearing by hand.

Some medical tapes are supplied with a release liner. If the tape is carried on a release liner, a suitable length must be cut using a pair of scissors or the like and then the release liner removed by peeling it from the tape prior to use.

It is known in the art to perforate the structural layer(s) of a medical tape in order that it may be hand-torn.

WO 95/06450 discloses a linerless adhesive tape comprising a binder-containing nonwoven web coated on one surface with a pressure-sensitive adhesive. The tape has laterally extending lines of perforations that enable lengths of tape to be dispensed by tearing along the perforated lines.

U.S. Pat. No. 4,346,700 discloses pressure-sensitive adhesive sheet materials such as tapes and surgical drapes that are skin and joint conformable and comprise a backing consisting essentially of chlorinated polyethylene and a pressure-sensitive adhesive on at least a portion of a surface thereof. Because the backing material has low water vapour permeability, the backing sheet is preferably provided with closely spaced perforations to provide satisfactory water vapour transmission. The perforated construction also provides for easy tearability.

U.S. Pat. No. 5,213,565 discloses tapes for attaching bandages, which have non-adhesive tabs at each end for easy manipulation and removal while wearing gloves. The tape may be formed in a roll, each tape section being separated from the others by a perforated section along the centre of the non-adhesive area.

All of the above-mentioned disclosures concern medical tapes comprising a pressure-sensitive adhesive.

For most medical applications, it is desirable to use a medical tape that adheres strongly to the skin. For example, the tape must be firmly affixed in order to secure tubes or other medical devices in place. In wound dressing applications, adherence must be sufficient to seal the wound margins in order to maintain a sterile environment, to prevent leakage of exudate and minimise the risk of maceration of the surrounding skin.

Numerous pressure-sensitive adhesives are known in the art. Pressure-sensitive adhesives are generally aggressively and permanently tacky at room temperature and firmly adhere to the skin, or any other surface, upon contact. Although providing adequate adherence when in use, there are several well-recognised problems associated with the use of these adhesives. Indeed, because of the widespread use of pressure-sensitive adhesives, these are the main problems associated with the use of medical tapes in general, namely skin stripping, adhesive transfer onto the skin, allergic response, and pain, eg as a result of skin stripping, wound disturbance and/or the removal of body hair. The problems are of course exacerbated when the medical tape is used on fragile or sensitive skin and when repeated tape applications are required over the same site.

Medical pressure-sensitive adhesives are typically synthetic polymers such as acrylic-based adhesives, polyvinyl ether-based adhesives, polyvinyl pyrrolidone-based adhesives and urethane-based adhesives.

Pressure-sensitive adhesives used in medical applications to bond to skin should show a high moisture vapour transmission rate, eg to avoid or minimise the risk of skin lesions caused by moisture accumulation. Typically the adhesives with maximum moisture vapour transmission are formulated from acrylic copolymers containing non-bound hydrophilic groups such as hydroxyl or carboxylic acid, polyurethanes, or vinyl ethers.

Pressure-sensitive adhesives that are less strongly adhesive, and hence which are less likely to cause trauma when removed from the skin, are available. However, if the level of adhesion is reduced in order to mitigate the above problems, then the level of adherence may be insufficient for many common applications, such that the tape has limited utility.

The use of a hydrophobic gel such as a soft silicone gel as a releasably adhesive skin contact layer is known.

WO 2007/113597 describes a releasably adhesive laminate suitable for use in a wide variety of applications, in particular for use against the skin and more particularly as part of a wound dressing. The releasably adhesive laminate comprises a structural layer carrying on at least one part of one side a hydrophobic gel and on at least one part of the other side a pressure-sensitive adhesive. The structural layer is preferably a film of synthetic plastics material, eg polyurethane. The pressure-sensitive adhesive is preferably an acrylic adhesive and the hydrophobic gel layer is preferably a soft silicone gel.

The laminate described in WO 2007/113597 is particularly advantageous for use as the skin contact layer of a wound dressing. The laminate also has particular utility for releasably securing items to the skin, eg items of clothing. The item is attached to a patch of the laminate via the pressure-sensitive adhesive.

The principal benefit of a soft silicone skin-contacting layer is that soft silicone is highly conformable and easy to apply and remove. Soft silicone adheres readily and securely to dry skin and other surfaces. Nevertheless, a soft silicone layer can be peeled away easily without damaging the surface of the skin and without leaving an adhesive residue. Other benefits include the fact that silicones are non-toxic, non-allergenic or non-sensitising, do not shed particles or fibres, feel soft on the skin and are conformable yet robust.

Soft silicone gels are particularly useful as the skin contacting layer of atraumatic wound dressings because, although they readily adhere to dry skin, they will not stick to the surface of a moist wound.

Numerous published papers describe the properties of silicone and the use of soft silicone dressings. There are different types of soft silicone dressings currently on the market, including atraumatic wound contact layers, absorbent dressings for exuding wounds and dressings for the treatment of hypertrophic scars and keloids.

Soft silicone medical tapes are also available, eg soft silicone tapes sold under the trade name Mepitac® by Mölnlycke Healthcare. Mepitac® consists of a soft silicone layer, a knitted fabric and a breathable polyurethane film.

The ease of removal of soft silicone from the skin is an important benefit, reducing pain and discomfort for the patient and avoiding the usual secondary problems associated with the use of medical tapes. If inspection and repositioning is necessary, the tape can be lifted and re-applied with little or no loss of adherence.

Mepitac® is supplied on a roll carried on a release liner. The desired length of Mepitac® is released from the roll by unwinding the desired length and cutting through the tape and the release liner with a pair of scissors or the like and then removing the release liner by peeling it from the tape prior to use.

However, there still exists a need for an improved medical tape having the advantages associated with the use of a soft silicone skin contacting layer, but which can be dispensing quickly and easily by tearing, rather than cutting with scissors.

It is not possible to tear Mepitac®. In particular, the nature of knitted fabric is that it has an open structure and is conformable and elastic, the degree to which the knitted fabric will stretch depending on the material and the knitting pattern.

Even if a knitted fabric were perforated, such that the perforations cut across some of the fibres in a transverse manner, an attempt to tear the fabric along the perforations would result in considerable stretching of the fabric in the longitudinal direction. The fabric could not be torn without applying a considerable pulling force in the longitudinal direction in order to break the fibres holding the fabric together between the perforations.

For that reason, it is extremely difficult to tear a perforated medical tape like Mepitac® comprising a polyurethane top layer, a knitted fabric and a soft silicone skin-contacting layer carried on a release liner. The fabric would be stretched and deformed, pulling apart from the release liner, and the mechanical integrity of the tape would be lost, eg by the fabric coming apart from the soft silicone and/or polyurethane layer. Certainly, the tape edge would be distorted and may be unattachable as a result.

There thus exists a need for a tape with soft silicone adhesive which can be dispensed in roll form without the need for cutting, and which tears cleanly and evenly.

According to the first aspect of the invention there is provided an adhesive tape comprising a structural layer carrying on at least one part of one side thereof a hydrophobic gel and on at least part of the other side thereof a backing layer, the tape having separation lines comprising perforations extending laterally across the tape at regular intervals along the length of the tape, and the structural layer comprising a synthetic material in the form of a film or non-woven web.

The adhesive tape according to the invention is advantageous primarily in that it has all the advantages associated with the use of hydrophobic gel as the skin contact layer and it is also perforated in order that lengths of tape can be dispensed quickly and easily from a roll by tearing by hand, and they can be torn cleanly, ie without curling edges.

The tape is suitable for a wide range of applications, but particularly as a medical tape for securing wound dressings, tubing and catheters. It is particularly suitable for patients with fragile and/or sensitive skin, and where repeated application and removal of the tape over the same area is required, eg in the case of neonates and dialysis patients.

The tape according to the invention is preferably supplied as a roll, and preferably within a suitable container, eg cardboard box, that is convenient for a medical practitioner to carry around.

Thus, according to a second aspect of the invention, there is provided a roll of adhesive tape, said tape comprising a structural layer carrying on at least one side thereof a hydrophobic gel and on at least part of the other side thereof a backing layer, the tape having separation lines comprising perforations extending laterally across the tape at regular intervals along the length of the tape, and the structural layer comprising a synthetic material in the form of a film or non-woven web.

The hydrophobic gel that is carried on one side of the structural layer is most preferably a soft silicone (ie silicone gel).

Most preferably, suitable soft silicones are formed by reaction between two components that are mixed immediately prior to application to the structural layer. Suitable components that are intended for such reaction to form a silicone gel are readily available commercially. Typically, the two components are a vinyl substituted silicone and a hydride-containing silicone.

Soft silicones having different properties may be produced by varying the proportions and/or nature of the components used in the reaction. For example, the molecular weights of the various components and/or their degree of substitution by reactive groups may be different.

Suitable components for forming a soft silicone layer for use as the skin contacting layer in the tape of the present invention are readily available.

The hydrophobic gel may be coated onto the structural layer at a wide variety of coating weights. The most appropriate coating weight will depend on the properties of the gel and its intended application. Typically, the gel may be coated onto the structural layer at a weight of between 50 g/m² and 800 g/m². The thickness of the gel may typically be between 5 μm and 10 mm, more commonly between 20 μm and 5 mm. For most applications, the thickness of the gel will be less than 2 mm, more commonly less than 1 mm, and the thickness of the gel will generally be greater than about 0.2 mm, or greater than about 0.4 mm.

The structural layer most preferably has the form of a relatively thin film of a synthetic plastics material. A wide variety of plastics may be suitable for use as the structural layer. Examples include polyvinylchloride, polypropylene and regenerated cellulose. However, the currently preferred material for the structural layer is polyurethane, and in particular melt-blown polyurethane.

The thickness of the structural layer may typically be between 5 μm and 1 mm, more preferably between about 20 μm and 0.2 mm, and more preferably between about 20 μm and 100 μm. Typically, the structural layer will have a thickness of less than 200 μm, or less than 100 μm, and a thickness of at least 10 μm or at least 20 μm. The tape is provided with a backing layer, providing a protective layer that is exposed during use. It is usually desirable for a medical tape to be breathable and/or water resistant, and the material and the nature of the backing layer is chosen accordingly. The backing layer may also be chosen to add strength.

The backing layer may comprise any suitable material. Preferred materials are synthetic polymers, for example polyurethane. In preferred embodiments of the present invention the backing layer is a polyurethane film.

Both the structural layer and the backing layer preferably exhibit a relatively high moisture vapour transmission rate (MVTR). The MVTR of the structural layer and of the backing layer may be at least 300 g/m²/24 h, more suitably at least 500 g/m²/24 h and preferably at least 700 g/m²/24 h at 37° C. at 100% to 10% relative humidity difference.

A pressure-sensitive adhesive may be used to secure the backing layer to the structural layer.

The pressure-sensitive adhesive may be any one of numerous pressure-sensitive adhesives known in the art. Such adhesives generally in dry (solvent free) form are aggressively and permanently tacky at room temperature and firmly adhere to a variety of dissimilar surfaces upon contact, without the need for more than finger or hand pressure. Generally they require no activation by water, solvent or heat in order to exert a strong adhesive holding force. Examples of pressure sensitive adhesives include rubber/resin adhesive, which is a mixture of a rubbery material and a hard resin, and acrylic (or acrylate) adhesives. The currently preferred class of pressure-sensitive adhesive for use in the present invention is acrylic adhesive.

The presence of the pressure-sensitive adhesive coating on the structural layer is also advantageous during manufacture because it acts as a sealant, preventing the hydrophobic gel mixture from striking through or permeating the structural layer prior to curing.

It is also advantageous for the tape to be carried on a release liner so that the soft silicone coating is not contaminated or damaged by the user when dispensing the product, eg when they grip the tape in order to tear it. The release liner also serves to maintain the mechanical integrity of the tape during unwinding and tearing. Further advantages are that the release liner may make the tape easier to handle and position, with or without gloves.

The layer of hydrophobic gel is thus most preferably protected by a release liner that is removed to expose the hydrophobic gel immediately prior to use. The release liner may be formed from a suitable plastics material, eg high density polyethylene (HDPE).

The release liner is most preferably formed in such a way as to be readily grasped and removed. For example, the release liner may be wider than the tape in order that an edge of the liner may be held between the thumb and index finger or middle finger of one hand whilst the tape is peeled away from the liner with the other hand. In preferred embodiments, the release liner is at least 10% wider than the tape, and may be at least 15% or 20% wider. The release liner may be up to about 50% wider than the tape, or up to about 40% or 30% wider. For instance, the release liner may be 10-50% wider than the tape, more preferably 20-30% wider than the tape. For example, the release liner may be about 25% wider than the tape.

The release liner may be a single component or it may comprise more than one component. Preferably, the release liner is textured to improve gripping thereof by a user and facilitate removal from the hydrophobic gel.

The width of the tape is preferably at least about 10 mm, more preferably at least about 15 mm and most preferably at least about 20 mm. The width of the tape is preferably no greater than about 100 mm, more preferably no greater than about 70 mm, and most preferably no greater than about 40 mm. Thus, the width of the tape is preferably between about 10 mm and 100 mm, more preferably between about 15 mm and 70 mm, and most preferably between about 20 mm and 40mm. The most preferable width is about 25 mm.

The tape is provided with separation lines comprising perforations extending laterally across the tape at regular intervals along the length of the tape. Clearly, the distance between the separation lines determines the shortest length of the tape that may be torn from the roll without requiring the use of scissors. Preferably the distance between separation lines is between about 10 mm and 300 mm, more preferably between about 30 mm and 150 mm, more preferably between about 40 mm and 100 mm, and most preferably between about 40 mm and 70 mm along the length of the tape.

The perforations may be any shape, including circular, elliptical, linear, arrow- or V-shaped, or Y-shaped perforations. However, a simple linear pattern of slits is preferred, in which the slits are aligned to create a single, broken separation line that extends laterally across the width of the tape.

Preferably, the slits are of equal length. Preferably, the length of the slits is about 0.5 mm to 5 mm, more preferably about 1 mm to 4 mm, most preferably between about 2 mm and 3 mm. Preferably, the gap between slits is uniform. Preferably, the gap between the slits is about 0.5 mm to 5 mm, more preferably about 1 mm to 4 mm, and most preferably between about 1 mm and 3 mm.

The sizes of the perforations and the distance between them are important in determining the force required to tear a length of the tape from the roll.

For certain applications, it may be beneficial for the tape to be formed with a regular array of apertures or perforations substantially throughout its entire structure. This may be appropriate where enhanced flexibility or conformability is required, or where it is desirable to reduce the area of the hydrophobic gel that is in contact with the skin, or to provide enhanced moisture or moisture vapour transmission characteristics.

The tape according to the invention may be manufactured in various ways. A currently preferred method of manufacture comprises the steps of:
a) providing a preformed pre-laminate comprising the structural layer and a pressure-sensitive adhesive;
b) applying to the pre-laminate a curable hydrophobic gel precursor composition;
c) causing or allowing the gel precursor composition to cure, thereby forming a layer of hydrophobic gel; and
d) laminating a backing layer onto the pressure-sensitive adhesive.

Where the hydrophobic gel is a silicone gel, the hydrophobic gel precursor composition is preferably prepared by mixing immediately prior to application to the structural layer. Typically, such a composition will comprise a vinyl substituted silicone and a hydride-containing silicone.

Steps a), b) and c) of the above manufacturing method are preferably carried out with a temporary covering applied to the pressure-sensitive adhesive. Such a covering may, for instance, comprise a paper sheet. Where a temporary covering is used, such a covering is removed, most preferably after curing of the hydrophobic gel, prior to lamination of the backing layer onto the pressure-sensitive adhesive.

The method preferably further comprises the application to the hydrophobic gel of a release liner.

Most preferably, the pre-laminate has a width in excess of several times the desired final width of the tape, so that the product may be cut lengthwise to yield a plurality of tapes according to the invention.

In a currently most preferred embodiment of the invention, after application of the backing layer and release liner, the product is cut lengthwise into ribbons. Conveniently, such cutting is by means of a rotary die. At the same time, partially penetrating cuts are made through the backing layer, support layer and hydrophobic gel, but not through the release liner. These cuts create marginal strips of tape that may be peeled away from the release liner and discarded, with the result that the release liner has a greater width than the tape. The partially penetrating cuts are preferably formed by cutting edges on a rotary die that are of slightly lesser depth than those that completely cut through the product to create the ribbons of tape.

The separation lines comprising perforations are preferably formed in the same operation as the cutting of the product into ribbons. Advantageously, a rotary die that cuts the product lengthwise to form the ribbons also carries transverse cutting elements that form the perforations.

The tape is most preferably wound into a roll, the roll comprising a length of tape that is typically from about 0.5 m to 10 m, more commonly from about 0.5 m to 2, 3 or 4 m.

An embodiment of this invention will now be described in greater detail, by way of illustration only, with reference to the accompanying drawings, in which

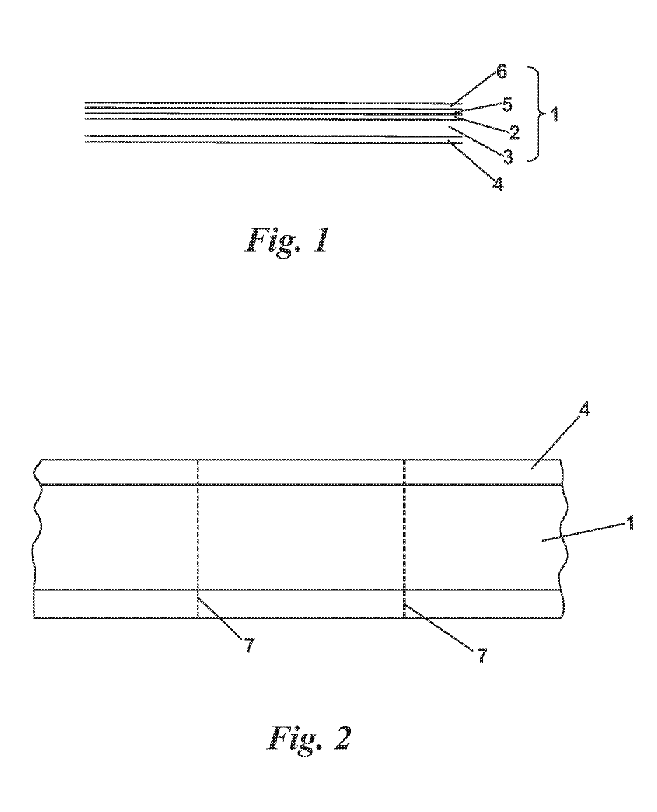

FIG. 1 is a partial cross-sectional view, schematic and not to scale, of a section of tape according to the invention;

FIG. 2 is a plan view, again schematic and not to scale, of the tape shown in FIG. 1;

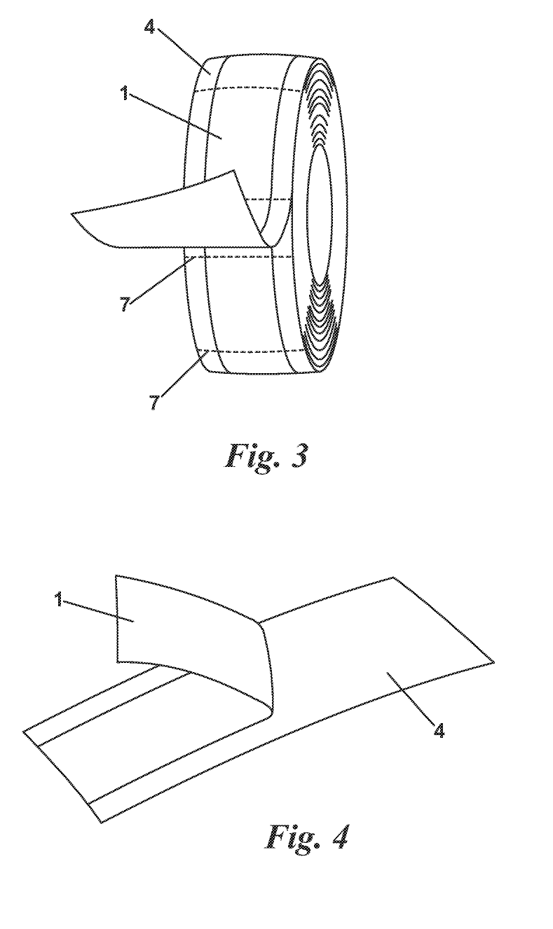

FIG. 3 is a perspective view, schematic and not to scale, of a roll of tape according to the present invention; and

FIG. 4 is a perspective view, schematic and not to scale, showing the removal of a piece of tape from a release liner.

Referring first to FIG. 1, a tape according to the invention is generally designated 1. The tape 1 comprises a structural layer 2 in the form of a film of melt-blown polyurethane. The structural layer 2 is coated on one side (the underside as viewed in FIG. 1) with a layer of soft silicone 3 (hydrophobic silicone gel). The thickness of the soft silicone layer 3 may vary depending on the intended use of the tape. However, the thickness of the soft silicone layer 3 is typically between 20 μm and 5 mm.

The surface of the soft silicone layer 3 that adheres to the skin or other surfaces during use is protected by a release liner 4, which is typically formed from high density polyethylene (HDPE).

On the other side (the upper side as viewed in FIG. 1), the structural layer 2 is coated with a layer of acrylic contact adhesive 5 which in turn carries a breathable and water-resistant polyurethane backing layer 6.

As shown in FIGS. 2 and 3, the release liner 4 is wider than the adhesive tape itself to facilitate removal prior to use. The tape 1, including the release liner 4, is provided with lines of perforations 7 extending laterally across the tape at regular intervals along the length of the tape. In the most preferred embodiment shown in the Figures, the separation of the lines of perforations is about 50 mm.

The perforations are regularly spaced linear slits of equal length. The length of the slits is about 2.5 mm, and the space between slits is 1.5 mm.

The tape 1, carried on a release liner 4, may be manufactured as follows. First, a pre-formed pre-laminate consisting of the structural layer 2, acrylic adhesive layer 5 and a paper covering is fed to a conveyor that transports the pre-laminate through successive stations of a manufacturing line. The conveyor preferably comprises one or more looped belts, eg of PTFE-coated glass fibre. Suction may be applied from beneath the belts to hold the pre-laminate flat during at least the initial stages of the manufacturing process. The pre-laminate is fed to the belt with the paper covering lowermost, ie with the paper backing in contact with the belt and the surface of the structural layer 2 opposite to that to which the acrylic adhesive 5 is applied uppermost.

At a first station of the manufacturing line, the silicone gel layer 5 is applied. As is conventional, the silicone gel layer 3 is formed by application of a curable mixture of two components via an applicator in which the two components are intimately mixed. Prior to curing, the mixture is fluid and can be applied as a uniform film with the desired thickness. The mixture may be applied by spraying, but more commonly is applied from the edge of a suitably formed blade that is positioned close to the surface of the laminate passing beneath it.

After application of the curable silicone mixture, the coated laminate passes into a first curing stage where the laminate passes beneath a bank of medium wave infra-red heaters that operate continuously. The thermal energy from these heaters initiates curing of the silicone mixture, and in particular cures the upper surface of the mixture, which maintains the structural integrity of the silicone layer during passage of the laminate through a second, longer curing stage. In the second curing stage, the laminate passes beneath further medium wave infra-red heaters. Curing of the silicone mixture, to form a layer of gel of the desired thickness and other properties, is completed during passage of the laminate through the second curing stage. The operating parameters may be optimised to suit the particular product being manufactured. Variables that may be adjusted include the power of the infra-red heaters, the speed of passage through the various stages of the process, as well as the length of the curing stages. Typically, the time taken for the laminate to pass through the curing stages is between 5 and 15 minutes. After completion of curing, the release liner 4 is applied to the exposed surface of the silicone gel layer.

The laminate is fed through an assembly line in which the paper covering is stripped off and a breathable polyurethane backing layer 6 is applied to the exposed layer of acrylic adhesive 5. The polyurethane backing layer 6 may be clear or coloured. Preferably, the polyurethane backing layer 6 is neutral or skin tone in colour, eg pink or beige.

The tape 1 is preferably manufactured in sheet form, on a continuous roll that may be up to approximately 100 m long and up to 3 m wide. The sheet is slit into ribbons using a rotary die, and at the same time it is perforated.

The currently preferred method for manufacturing a tape 1 such as that illustrated, in which the release liner is wider than the rest of the tape, is to use the rotary die to form, on each side of the fully penetrating cut that separates the sheet into ribbons, also a partially penetrating cut. By a partially penetrating cut it is meant that the cutting edges are set to cut though the tape only as far as the release liner. The thin ribbons of excess tape material are stripped off the release liner to expose the release liner on each side of the tape.

The rotary die is also provided with one or more serrated perforator blades extending longitudinally along the length of the roller but transversely to the conveying direction of the continuous sheet, creating perforated lines at the same time as the sheet is slit into ribbons.

If desired for a particular application, the perforated lines may be marked with a pigment so that the user can more easily see where to tear the tape. Marking can be carried out at the point of perforation, eg on the backing layer 6, or one or more of the layers could be marked at an earlier point in the manufacturing process. It may be possible to mark one of the internal layers, in order that the pigment is not exposed to the skin, provided that the markings are still visible through the covering layers. Alternatively, it may be useful to mark only the release liner, since it is removed prior to use after a piece of the tape has been torn from the roll. This may be advantageous both because the skin is not then exposed to the pigment and for aesthetic reasons. The tape may similarly be marked with instructions and/or marketing information.

1.-33. (canceled)

34. An adhesive tape comprising:
a structural layer comprising a synthetic material in the form of a film or non-woven web, the structural layer carrying on at least one part of one side thereof a hydrophobic gel and on at least part of the other side thereof a backing layer,
wherein the tape has separation lines comprising perforations extending laterally across the tape at regular intervals along the length of the tape, in order that lengths of tape can be dispensed by tearing.

35. The tape according to claim 34, wherein the hydrophobic gel that is carried on one side of the structural layer is a soft silicone.

36. The tape according to claim 35, wherein the thickness of the gel is between 5 μm and 10 mm.

37. The tape according to claim 35, wherein the thickness of the gel is between 20 μ, and 5 mm.

38. The tape according to claim 34, wherein the structural layer has the form of a film comprising a synthetic plastics material.

39. The tape according to claim 38, wherein the synthetic plastics material is a melt-blown polyurethane.

40. The tape according to claim 34, wherein the thickness of the structural layer is between 5 μm and 1 mm.

41. The tape according to claim 34, wherein the backing layer comprises a polyurethane film.

42. The tape according to claim 34, wherein both the structural layer and the backing layer exhibit a moisture vapour transmission rate of at least 300 g/m²/24 h.

43. The tape according to claim 34, further comprising a pressure-sensitive adhesive that secures the backing layer to the structural layer.

44. The tape according to claim 34, wherein the tape is carried on a release liner.

45. The tape according to claim 44, wherein the release liner is wider than the tape.

46. The tape according to claim 45, wherein the release liner is at least 10% wider than the tape.

47. The tape according to claim 34, wherein the width of the tape is between about 10 mm and 100 mm.

48. The tape according to claim 34, wherein the distance between separation lines is between about 10 mm and 300 mm.

49. The tape according to claim 34, wherein the perforations comprise slits arranged in a line that extends laterally across the width of the tape.

50. The tape according to claim 49, wherein the length of the slits is about 0.5 mm to 5 mm.

51. The tape according to claim 34, wherein the tape is supplied in the form of a roll.

52. A method of manufacturing the tape according to claim 34, the method comprising the steps of:
a) providing a preformed pre-laminate comprising the structural layer and a pressure-sensitive adhesive;
b) applying to the pre-laminate a curable hydrophobic gel precursor composition;
c) causing or allowing the gel precursor composition to cure, thereby forming a layer of hydrophobic gel;
d) laminating a backing layer onto the pressure-sensitive adhesive; and
e) creating lines of perforations extending laterally across the tape at regular intervals along the length of the tape.

53. The method according to claim 52, further comprising:
applying a release liner to the layer of hydrophobic gel.

54. The method according to claim 53, wherein the preformed pre-laminate has a width several times the desired final width of the tape, and the method further comprises cutting of the tape lengthwise to yield a plurality of tapes.
